(19) United States
(12) Patent Application Publication
(10) Pub. No.: US 2009/0269166 A1
(43) Pub. Date: Oct. 29, 2009

(54) METHOD AND SYSTEM FOR MECHANICALLY BINDING A BOOK SPINE

(75) Inventor: Paul N. Richards, Fairport, NY (US)

Correspondence Address: Xerox Corporation;c/o ORTIZ & LOPEZ, PLLC, P. O. BOX 4484, ALBUQUERQUE, NM, 87196-4484, US

(73) Assignee: Xerox Corporation.

(21) Appl. No.: 12/108,880

(22) Filed: Apr. 24, 2008

(51) Int. Cl. B42B 5/08; B42C 9/00; B42B 5/06

(52) U.S. Cl. 412/7; 412/8; 412/37; 412/34

(57) ABSTRACT

Method and system for permanently fastening an in-line plastic book spine utilizing bind spine tabs. Paper sheets can be formed into an aligned book block. A set of rectangular holes can be configured on binding edges of the paper sheets and book covers. Each bind spine tab can be inserted into the rectangular holes and connected with a binding strip utilizing a mechanical material fastening process, an ultrasonic sealing/welding process and/or a mechanical tab fastening process. The mechanical material fastening process can fasten the book spine together by a stitch or piercing a mechanical material therein. The ultrasonic sealing/welding process can apply ultrasonic waves on the spine tab and the strip to bond together. The mechanical tab fastening process can insert a pre-cut series of mechanical tabs into die-cut slots on a mating side of the book spine.

### TECHNICAL FIELD

Embodiments are generally related to book binders. Embodiments are also related to methods and devices for fastening book spines utilizing book spine tabs. Embodiments are additionally related to in-line plastic book spines for binding loose-leaf papers to form books or booklets.

### BACKGROUND OF THE INVENTION

In general, printed pages may be bound into a book utilizing various binding techniques. One common method involves stapling, which applies a set of staples to the loose-leaf papers. The total number of pages stapled together, however, is limited utilizing such a stapling method. Recently, a number of different techniques, such as, for example comb binding, spiral wire binding and coil binding, have been developed to bind loose-leaf papers together into a permanent assembly for forming books or booklets. Similarly, a relatively rigid but slightly resilient molded or extruded plastic spine type binder can also be produced for loose-leaf paper binding. Such binders might be elongated, one-piece U-shape members with two opposed legs and an interconnecting base web. This type of binder grips the entire edge of the papers to provide a firm union, but is expensive due to the labor cost increment.

Another conventional binding arrangement may employ ring-like plastic pieces with multiple prong ends, which can be inserted through aligned openings in the page edges and then locked in place. This arrangement might be accomplished by forming the plastic with an inherent self-curl, but is not preferable due to piece cost and storage problems. Such binding arrangements also increase the chances for malfunction or a reduction in quality, such as bent edges or misalignment of the papers. The above-mentioned commercially available binding methods may provide a temporary binding style with internally concealed metal or plastic rings to engage the loose leaf papers.

Some plastic multi-ring binding element systems, such as electric binding machines, manual binding machines, and combination punch and bind machines, have been implemented. Such binding systems may utilize a number of very closely spaced multiple plastic rings integrally attached to a plastic spine member. The binding system punches the front and rear cover as well as the loose leaf papers with a series of rectangular openings. Such plastic binding systems, however, may require two-piece cover sets with handling, filing, stacking, storing and provide an unpresentable appearance. Many of these well-known arrangements suffer certain disadvantages such as high cost or the need for relatively complex applicator machinery.

FIG. 1 illustrates an exterior view of a prior art auto binder bind spine 100 (iBind X1). The iBind X1 100 constitutes a punch-and-bind system utilized for many office documents. The iBind X1 100 utilizes an adhesive pad 210, as shown in FIG. 2, to permanently fasten the bind spine 100 together. The bind spine 100 associated with several bind spine tabs 120 and a strip of material 220, as depicted in the prior art illustration of FIG. 2, might be bonded by adhesives in the adhesive pad 210. The permanent bind takes place between an inside of a back cover and a backside of a last page in a book 110. Such a bind configuration 200 provided inside the book 110 is depicted in FIG. 2. In some embodiments, the bind spine 100 shown in FIGS. 1-2 can be provided in a flat state prior to insertion into the page holes, depending upon design considerations. The adhesive pad 210 applies the adhesives in the connection region of the bind spine tabs 120 and the material strip 220. The bind spine 100 binds the book 110 with ten sheets and/or hundred sheets by adhering to the bind spine tabs 120.

The majority of prior art auto binder bind spines 100 utilize adhesives for fastening the book spine 100 together. These adhesives exert the separation forces from the stack of papers during the bind process, and also bind-binding force (i.e. book integrity), which causes a “sticky” problem in the book 110. Such a bind spine 100 with the adhesive pad 210 exhibits less life time for both pre-binding and post-binding due to environmental conditions, which can adversely affect the adhesive properties. Additionally, the plastic spines 100 and the adhesive pad 210 are expensive to manufacture and also require a high inspection control on the adhesive forces during production. The release forces of the spine elements also create machine reliability problems due to high or low release forces during spine separation during the book making process.

A need therefore exists for an improved method for permanently fastening a plastic book spine utilizing book spine tabs which enables book binding without the need for adhesive pads. Such an improved method is described in greater detail herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved method and system for permanently fastening an in-line plastic book spine utilizing book spine tab.

It is another aspect of the present invention to provide for an in-line plastic book spine for binding loose-leaf papers to form books or booklets.

It is yet a further aspect of the present invention to provide for a method and system to mechanically fasten polyester (plastic) to a book spine to create a book or booklet.

The aforementioned aspects and other objectives and advantages can now be achieved as described herein. An improved method and system for permanently fastening an in-line plastic book spine utilizing bind spine tabs is disclosed. Paper sheets can be formed into an aligned book block. A set of rectangular holes can be configured on binding edges of the paper sheets and book covers. Each bind spine tab can be inserted into the rectangular holes and connected with a binding strip by means of a mechanical material fastening process, an ultrasonic sealing/welding process and/or a mechanical tab fastening process. The mechanical material fastening process can fasten the book spine together by stitch or piercing a mechanical material therein. The ultrasonic sealing/welding process can apply ultrasonic waves on the spine tab and the strip to bond together. The mechanical tab fastening process can insert a pre-cut series of mechanical tabs into die-cut slots on a mating side of the book spine.

The paper sheets can be stacked in an ordered manner. The rectangular hole on the paper sheets and the book cover can be spaced apart from each other at a regular distance and made along its bound edge. The mechanical material can be introduced between the bind spine tabs and the binding strip to form the book spine. The mechanical material fastening process can be similar to a sheet metal stitch or piercing process. The ultrasonic sealing/welding process can be commonly utilized in a production packaging industry (e.g., potato chip bags) by utilizing suitable devices.

Furthermore, the binding strip can be utilized for interconnecting the bind spine tabs in an in-line manner. The bind spine tabs and the binding strip can normally be made up of plastic which is easy and very flexible to open, alter and rebind. Therefore, the book spine can be most inexpensive and easiest to utilize. The method can permanently fasten the plastic book spine without the need of adhesive pads, which further reduces the cost for binding the loose-leaf papers to form the books or booklets.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates an exterior view of a prior art GBC auto binder bind spine;

FIG. 2 illustrates a prior art bind configuration provided inside a book;

FIG. 3 illustrates a flow chart of a method for permanently fastening an in-line plastic book spine by means of a mechanical material fastening process, in accordance with a preferred embodiment;

FIG. 4 illustrates a schematic view of a book bound with the bind spine by utilizing the mechanical material fastening process, in accordance with a preferred embodiment;

FIG. 5 illustrates a flow chart of a method for permanently fastening the in-line plastic book spine by means of an ultrasonic sealing/welding process, in accordance with an alternative embodiment;

FIG. 6 illustrates a flow chart of a method for permanently fastening the in-line plastic book spine by means of a mechanical tab fastening process, in accordance with an alternative embodiment; and

FIG. 7 illustrates a schematic view of the bind spine fastened by utilizing the mechanical tab fastening process, in accordance with an alternative embodiment.

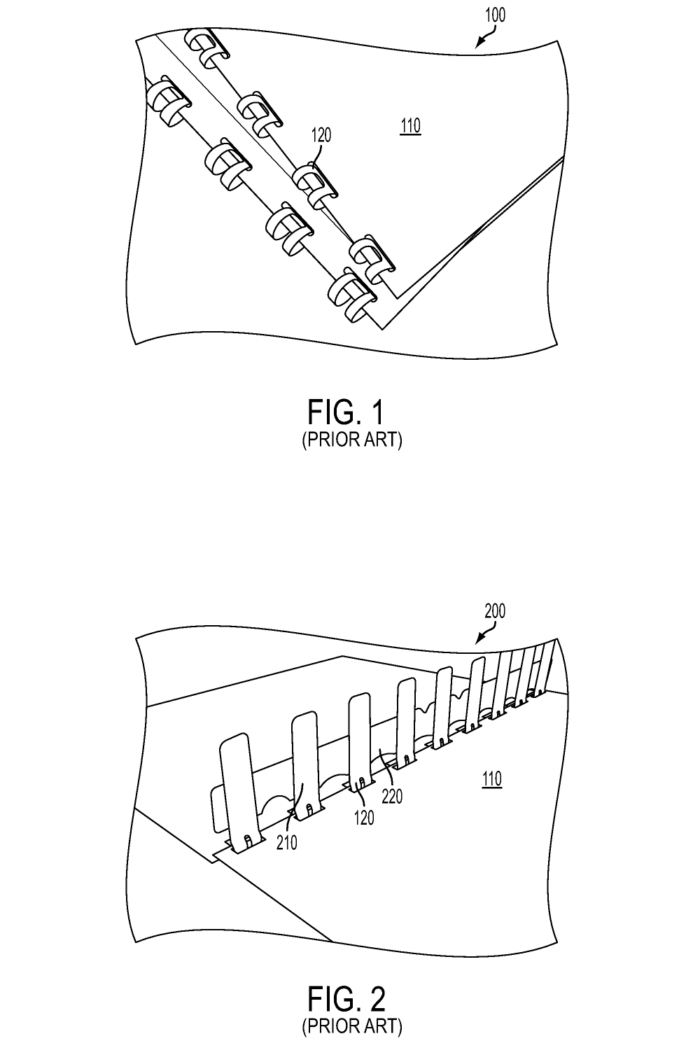

### DETAILED DESCRIPTION

The particular values and configurations discussed in these non-limiting examples can be varied and are cited merely to illustrate at least one embodiment and are not intended to limit the scope thereof.

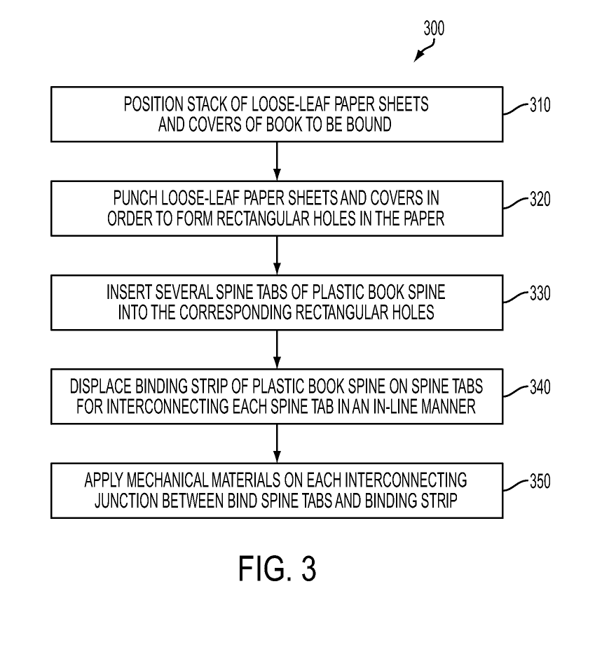

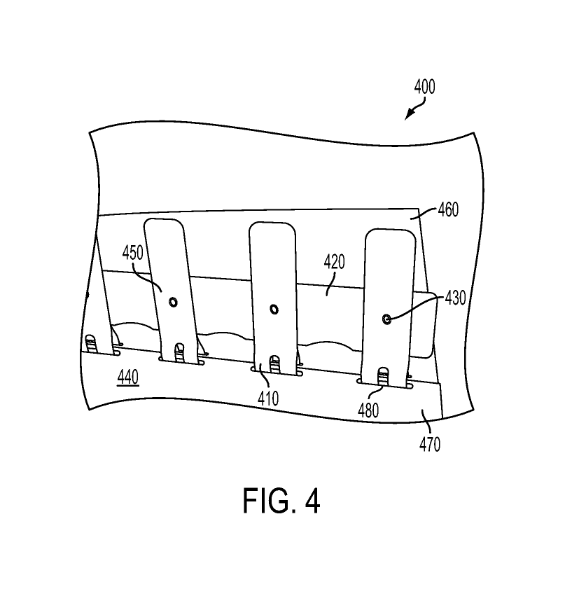

FIG. 3 illustrates a high-level flow chart of a method 300 for permanently fastening an in-line plastic book spine 400, as depicted in FIG. 4, by means of a mechanical material fastening process, in accordance with a preferred embodiment. Note that the method 300 is depicted in FIG. 3. As illustrated at block 310, a stack of loose-leaf paper sheets 460 and covers 470, (i.e. front and back cover), of a book 440 to be bound can be positioned in an ordered manner. As described at block 320, the loose-leaf paper sheets 460 and the covers 470 can be punched by a suitable punching tool (not shown) in order to form rectangular holes 480 in the paper sheets 460 and the covers 470. As depicted thereafter at block 330, several spine tabs 410 of the plastic book spine 400 can be inserted angularly into the corresponding rectangular holes 480. The spine tabs 410 can be angulated as U-shaped manner and dimensioned depending upon the design considerations. It can be appreciated, of course, that other shapes may be utilized to implement the spine tabs.

Next, as described at block 340, a binding strip 420 of the plastic book spine 400 can be displaced on the spine tabs 410 for interconnecting each spine tab 410 in an in-line manner. The binding strip 420 can be displaced in between the backside of the last paper sheet 460 in the book 440 and the inside of the back cover 470, as illustrated in FIG. 4. As indicated thereafter at block 350, mechanical materials 430 can be applied on each interconnecting junction 450 between the bind spine tabs 410 and the binding strip 420. The method 300 utilizes the mechanical materials 430 for permanently fastening the plastic book spine 400 instead of utilizing expensive adhesive pads, which avoids the separation forces from the stack of paper sheets 460 during the binding process.

FIG. 4 illustrates a schematic view of a book 440 bound with the bind spine 400 by utilizing the mechanical material fastening process, in accordance with a preferred embodiment. The book 440 can be formed with the stack of papers 460 and the covers 470 with the help of bind spine 400. The rectangular holes 480 on the paper sheets 460 and the book cover 470 can be spaced apart from each other at a regular distance and made along its bound edge. The mechanical material 430 can be introduced between the bind spine tabs 410 and the binding strip 420 to form the book spine 400, as clearly illustrated in FIG. 4.

Additionally, a hole or cut can be configured on the interconnecting junctions 450 in order to make insertion of the mechanical material 430 for permanent fastening of the book spine 400. The mechanical material fastening process can be similar to a sheet metal stitch or piercing process. Note that the embodiments discussed herein generally relate to book binding. It can be appreciated, however, that such embodiments can be implemented in the context of other systems and designs, and are not limited to the book binding. The discussion of book binding, as utilized herein, is presented for general illustrative purposes only.

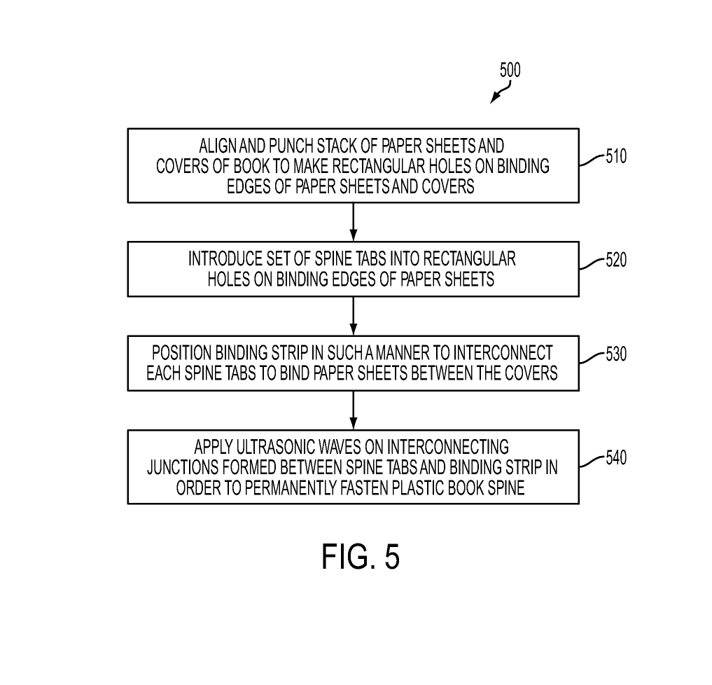

FIG. 5 illustrates a flow chart of a method 500 for permanently fastening the in-line plastic book spine 400 by means of an ultrasonic sealing/welding process, in accordance with an alternative embodiment. As illustrated at block 510, a stack of paper sheets 460 and covers 470 of the book 440 can be aligned and punched to make rectangular holes 480 on the binding edges of the paper sheets 460 and the covers 470. The stack of paper sheets 460 is aligned for positioning the paper sheets 460 with the binding edges thereof in a precise axial alignment to make accurate rectangular holes 480 thereon. As depicted at block 520, a set of spine tabs 410 can be introduced into the rectangular holes 480 on the binding edges of the paper sheets 460 and the covers 470 of the book 440.

Thereafter, as indicated at block 530, a binding strip 420 can be positioned in such a manner to interconnect each spine tabs 410 to bind the paper sheets 460 between the book covers 470 (as illustrated at FIG. 4). As described at block 540 ultrasonic waves can be applied on interconnecting junctions 450 formed between the spine tabs 410 and the binding strip 420 in order to permanently fasten the plastic book spine 400. Such ultrasonic welding can be done by utilizing a suitable welding tool (not shown) which produces the ultrasonic waves with high thermal forces in the form of mechanical vibrations. The mechanical vibrations are vertically introduced for raising the thermal forces on the interconnecting junctions 450 in order to press the spine tabs 410 and the binding strip 420 together without using any additional materials.

Furthermore, the ultrasonic sealing/welding process is commonly utilized in a production packaging industry, (i.e. Potato chip bags), by using suitable devices in a food industry. The ultrasonic sealing/welding process can emerge thermoplastics welding, since the bind spine tabs 410 and the binding strip 420 can normally be made up of plastic which is easy and very flexible to open, alter and rebind. It can be appreciated, of course, that other material may be utilized to implement the book spine 400. The ultrasonic sealing/welding process binds the binding strip 420 and the bind spine tabs 410 in an in-line manner. Note that in FIGS. 3-7 identical parts or elements are generally indicated by identical reference numerals.

In addition, the ultrasonic welding process can apply the ultrasonic waves with high thermal forces on the interconnecting junctions 450 in order to bind the spine tabs 410 and the binding strip 420 together. The simultaneous action of static and dynamic thermal forces causes a fusion of the spine tabs 410 and the binding strip 420 so that material in the spine tabs 410 and the binding strip 420 locally forges an insoluble connection between both the spine tabs 410 and the binding strip 420 within a very short period of time. The bind quality of the book spine 400 is very uniform since the energy transfer and the released internal heat remains constant in the ultrasonic welding process. Therefore, the ultrasonic welding process can also be named as a heat staking process.

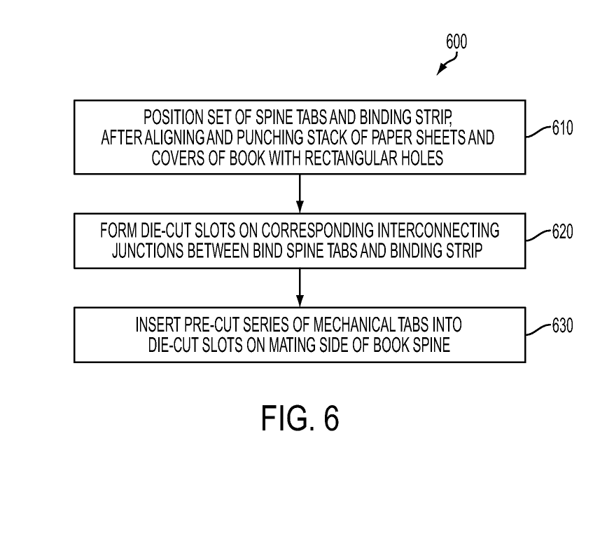

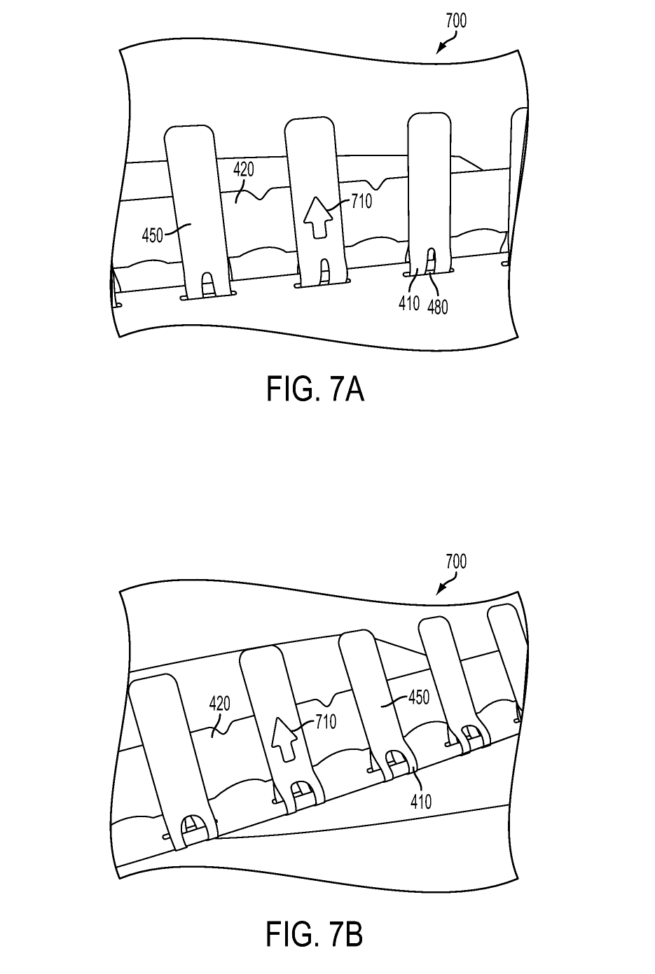

FIG. 6 illustrates a high-level flow chart of operations depicting a method 600 for permanently fastening the in-line plastic book spine 700, as shown in FIG. 7, by means of a mechanical tab fastening process, in accordance with an alternative embodiment. As depicted at block 610, the set of spine tabs 410 and the binding strip 420 can be positioned similarly as described in the methods 300 and 500 after aligning and punching the stack of paper sheets 460 and the covers 470 of the book 440 with rectangular holes 480. The rectangular holes 480 can be configured on binding edges of the paper sheets 460 and the covers 470 in an axial alignment. As depicted at block 620, die-cut slots (not shown) can be formed on corresponding interconnecting junctions 450 between the spine tabs 410 and the binding strip 420.

In addition, the die-cut slots are formed on an opposite or mating side of the book spine 700. As described at block 630, a pre-cut series of mechanical tabs 710 can be inserted into the die-cut slots on the mating side of the book spine 700, as illustrated in FIG. 7. The mechanical tabs 710 are identical and adapted to interfit the bind spine tabs 410 and the binding strip 420 in face-to-face relation to permanently retain the stack of paper sheets 460. The mechanical tabs 710 can especially be provided to interconnect the bind spine tabs 410 and the binding strip 420 with a variable spacing in accordance with the thickness of the paper sheets 460.

FIG. 7 illustrates a schematic view of a bind spine 700 fastened utilizing a mechanical tab fastening process, in accordance with an alternative embodiment. Note that in FIGS. 3-7 identical parts or elements are generally indicated by identical reference numerals. The mechanical tab fastening process utilizes mechanical tabs 710 for permanently fastening the book spine 700. These mechanical tabs 710 can be shaped and sized in various manners depending upon design considerations. The mechanical tabs 710 are free from bind-binding forces, (i.e. book integrity), of the final bind and separation forces due to the stack of paper sheets 710 during the binding process.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for fastening an in-line plastic book spine, comprising:
forming a plurality of rectangular holes on at least one binding edge of a plurality of paper sheets and a plurality of book covers, said plurality of paper sheets aligned into an aligned book block;
angularly inserting a plurality of bind spine tabs into said plurality of rectangular holes on said plurality of paper sheets and said plurality of book covers, wherein said plurality of bind spine tabs is associated with said plurality of paper sheets and said plurality of book covers; and
bonding said plurality of bind spine tabs with at least one binding strip in order to form a book bound by an in-line plastic book spine thereof.

2. The method of claim 1 further comprising bonding said plurality of bind spine taps with at least one binding strip by a mechanical material fastening process.

3. The method of claim 1 further comprising bonding said plurality of bind spine taps with at least one binding strip by an ultrasonic sealing process.

4. The method of claim 1 further comprising bonding said plurality of bind spine taps with at least one binding strip by a welding process.

5. The method of claim 1 further comprising bonding said plurality of bind spine taps with at least one binding strip by a mechanical tab fastening process.

6. The method of claim 2 wherein said mechanical material fastening process further comprises:
introducing at least one mechanical material on one or more interconnecting junctions formed between said plurality of bind spine tabs and said at least one binding strip.

7. The method of claim 3 wherein said ultrasonic sealing process further comprises:
applying ultrasonic waves with high thermal forces on said one or more interconnecting junctions in order to bind on said plurality of bind spine tabs and said binding strip.

8. The method of claim 5 wherein said mechanical tab fastening process further comprises:
forming a plurality of die-cut slots on said one or more interconnecting junctions; and
inserting a pre-cut series of mechanical tabs into said plurality of die-cut slots on a mating side of an in-line plastic book spine.

9. The method of claim 1 wherein said plurality of rectangular holes is spaced apart from each other at a regular distance.

10. The method of claim 2 wherein said mechanical material fastening process comprises a sheet metal stitch process.

11. The method of claim 2 wherein said mechanical material fastening process comprises a piercing process.

12. The method of claim 1 wherein each book cover among said plurality of book covers comprises a front cover and a back cover.

13. A system for fastening an in-line plastic book spine, comprising:
a plurality of rectangular holes formed on at least one binding edge of a plurality of paper sheets and a plurality of book covers, said plurality of paper sheets aligned into an aligned book block;
a plurality of bind spine tabs angularly inserted into said plurality of rectangular holes on said plurality of paper sheets and said plurality of book covers, wherein said plurality of bind spine tabs is associated with said plurality of paper sheets and said plurality of book covers; and
at least one binding strip for bonding said plurality of bind spine tabs in order to form a book bound by an in-line plastic book spine thereof.

14. The system of claim 13 wherein said plurality of bind spine taps is bonded with at least one binding strip by a mechanical material fastener.

15. The system of claim 13 further comprising wherein said plurality of bind spine tap is bonded with at least one binding strip by an ultrasonic seal.

16. The system of claim 13 further comprising bonding said plurality of bind spine taps with at least one binding strip by a weld.

17. The system of claim 13 further comprising bonding said plurality of bind spine taps with at least one binding strip by a mechanical tab fastener.

18. The system of claim 13 wherein said plurality of rectangular holes is spaced apart from each other at a regular distance and wherein each book cover among said plurality of book covers comprises a front cover and a back cover.

19. A system for fastening an in-line plastic book spine, comprising:
a plurality of rectangular holes formed on at least one binding edge of a plurality of paper sheets and a plurality of book covers, said plurality of paper sheets aligned into an aligned book block;
a plurality of bind spine tabs angularly inserted into said plurality of rectangular holes on said plurality of paper sheets and said plurality of book covers, wherein said plurality of bind spine tabs is associated with said plurality of paper sheets and said plurality of book covers; and
at least one binding strip for bonding said plurality of bind spine tabs in order to form a book bound by an in-line plastic book spine thereof, wherein said plurality of rectangular holes is spaced apart from each other at a regular distance and wherein each book cover among said plurality of book covers comprises a front cover and a back cover.

20. The system of claim 19 wherein said plurality of bind spine tabs is bonded with at least one binding strip by a mechanical material fastener, an ultrasonic seal, a weld, or a mechanical tab fastener.
